(19) United States
(12) Patent Application Publication
(10) Pub. No.: US 2025/0337128 A1
(43) Pub. Date: Oct. 30, 2025

(54) SECONDARY BATTERY

(71) Applicant: SAMSUNG SDI CO., LTD., Yongin-si (KR)

(72) Inventors: Tae Yoon LEE, Yongin-si (KR); Dong Myung LEE, Yongin-si (KR); Du Seon PARK, Yongin-si (KR); Byeong Gwan LEE, Yongin-si (KR); Duck Hyun KIM, Yongin-si (KR); Woon Suk JANG, Yongin-si (KR)

(21) Appl. No.: 19/011,794

(22) Filed: Jan. 7, 2025

(30) Foreign Application Priority Data
Apr. 30, 2024 (KR) 10-2024-0057314

(51) Int. Cl. H01M 50/533; H01M 50/107; H01M 50/186; H01M 50/474; H01M 50/534; H01M 50/559; H01M 50/566; H01M 50/627

(52) U.S. Cl. CPC H01M 50/533; H01M 50/107; H01M 50/186; H01M 50/474; H01M 50/534; H01M 50/559; H01M 50/566; H01M 50/627

(57) ABSTRACT

The present disclosure relates to a secondary battery that enables injection of an electrolyte by including an injection port in a positive electrode, provides welding strength for welding the positive electrode terminal, and makes detecting defects easier. In an embodiment the secondary battery comprises a cylindrical can having a through-hole formed therein. An electrode assembly is accommodated in the can, with the electrode assembly including a first tab and a second tab. A current collector plate is accommodated in the can, connected to the first tab, and includes a current collector plate injection hole. A rivet terminal is coupled to the through-hole and electrically connected to the first tab. The rivet terminal includes a rivet injection hole through which an electrolyte may be injected.

### CROSS-REFERENCE TO RELATED APPLICATION

This application claims priority to and the benefit of Korean Patent Application No. 10-2024-0057314 filed on Apr. 30, 2024, in the Korean Intellectual Property Office, the entire disclosure of which is incorporated herein by reference.

### BACKGROUND

### 1. Field

The present disclosure relates to a secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage).

Such secondary batteries may be classified into cylindrical, prismatic, pouch, etc., depending on their appearance. Among them, a cylindrical secondary battery typically may include an electrode assembly, a can, a cap assembly, etc. An electrolyte is injected into a secondary battery through an injection port and then the injection port is sealed by a blind rivet. But, as the injection port is sealed with the blind rivet, it can be difficult to ensure sealability and inspect defects and the blind rivet configuration can be expensive to manufacture.

The above information disclosed in this Background section is for enhancement of understanding of the background of the present disclosure, and therefore, it may contain information that does not constitute related (or prior) art.

### SUMMARY

The present disclosure provides a secondary battery that facilitates an injection process by having an injection port on a positive electrode, has good strength for welding of a positive electrode terminal, and facilitates the detection of defects.

These and other aspects and features of the present disclosure will be described in or will be apparent from the following description of embodiments of the present disclosure.

An exemplary secondary battery according to an embodiment of the present disclosure may include: a cylindrical can having a through-hole formed therein; an electrode assembly accommodated in the can, the electrode assembly including a first tab and a second tab; a current collector plate accommodated in the can, the current collector plate being connected to the first tab, and the current collector plate including a current collector plate injection hole; and a rivet terminal coupled to the through-hole and electrically connected to the first tab, wherein the rivet terminal includes a rivet injection hole through which an electrolyte may be injected.

In some examples, the current collector plate injection hole and the rivet injection hole may be coupled to each other at positions corresponding to each other.

In some examples, the can may include an upper surface, a side wall portion extending from the periphery of the upper surface, and a bottom portion having an opening, and the through-hole may be formed in the upper surface.

In some examples, the can may further include a bottom plate that closes the opening in the bottom portion of the can to isolate the electrode assembly and the first current collector plate from outside of the can, and the bottom plate may be coupled to the bottom portion of the can.

In some examples, the bottom plate may be electrically connected to the second tab.

In some examples, the can may include a bottom portion, a side wall portion extending from the periphery of the bottom portion, and an upper surface having an opening formed therein.

In some examples, the can may further include a cap plate that closes the opening in the upper surface of the can to isolate the electrode assembly and the current collector plate from outside of the can, and the cap plate may be coupled to the upper surface of the can.

In some examples, the can may be electrically connected to the second tab.

In some examples, the first tab and the second tab protrude from the electrode assembly in the same direction.

In some examples, the current collector plate is a first current collector plate, and the secondary battery includes a second current collector plate positioned beside the first current collector plate and electrically connected to the second tab may be further included.

In some examples, an insulating gasket positioned between the first current collector plate and the second current collector plate may be further included.

In some examples, the first tab and the second tab protrude from the electrode assembly in opposite directions.

In some examples, a welding line may be formed on the top of the rivet terminal where the rivet terminal is connected to the current collector plate.

In some examples, an upper side of the rivet injection hole of the rivet terminal and an upper side of the current collector plate injection hole may be coupled to each other by laser welding.

In some examples, the welding line may be formed along the periphery of the rivet injection hole.

In some examples, the welding line corresponds to the shape of the rivet injection hole.

In some examples, the welding line may be in any of circular, dotted, and wobble shaped.

In some examples, the rivet terminal may further include a sealing portion positioned in the rivet injection hole.

In some examples, a sealing portion that seals the rivet injection hole and the current collector plate injection hole may be further included.

In some examples, the sealing portion includes aluminum, an aluminum alloy, copper, a copper alloy, nickel, or a nickel alloy.

### BRIEF DESCRIPTION OF DRAWINGS

The drawings attached to this specification illustrate embodiments of the present disclosure, and further describe aspects and features of the present disclosure together with the detailed description of the present disclosure. Thus, the present disclosure should not be construed as being limited to the drawings:

FIGS. 1 and 2 are cross-sectional and perspective views showing an exemplary secondary battery according to an embodiment of the present disclosure.

FIGS. 3 and 4 are cross-sectional and perspective views showing an exemplary secondary battery according to another embodiment of the present disclosure.

FIG. 5 is an enlarged cross-sectional view showing area 5 of FIG. 1.

FIG. 6 is a plan view showing a welding line of a rivet terminal according to an embodiment of the present disclosure.

FIG. 7 is a plan view showing a welding line of a rivet terminal according to another embodiment of the present disclosure.

FIG. 8 is a plan view showing a welding line of a rivet terminal according to still another embodiment of the present disclosure.

FIG. 9 is a cross-sectional view showing a secondary battery having an exemplary bottom plate structure according to another embodiment of the present disclosure.

FIG. 10 is a perspective view showing a secondary battery having an exemplary cap plate structure according to another embodiment of the present disclosure.

FIG. 11 is an enlarged cross-sectional view showing area 11 of FIG. 9.

FIG. 12 is a diagram showing the shapes of a first current collector plate and a second current collector plate in a secondary battery having positive and negative electrode tabs protruding in one direction, according to an embodiment of the present disclosure.

FIGS. 13A and 13B are diagrams schematically showing the configuration of a secondary battery pack according to an embodiment of the present disclosure.

FIG. 14A is a perspective view showing an exemplary vehicle body.

FIG. 14B is a diagram for explaining a vehicle including the secondary battery pack of FIGS. 13A and 13B.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it will be understood that when an element is referred to as being “coupled,” “linked” or “connected” to another element, the elements may be directly “coupled,” “linked” or “connected” to each other, or an intervening element may be present therebetween, through which the element may be “coupled,” “linked” or “connected” to another element. In addition, when a part is referred to as being “electrically coupled” to another part, the part can be directly connected to another part or an intervening part may be present therebetween such that the part and another part are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the disclosure.

In some embodiments of the cylindrical-type battery according to an embodiment of the present disclosure, one of the cylindrical-type batteries is selected, and the selected battery is described as having a general structure, and for commonly applied technologies, describe the general structure of cylindrical-type cells.

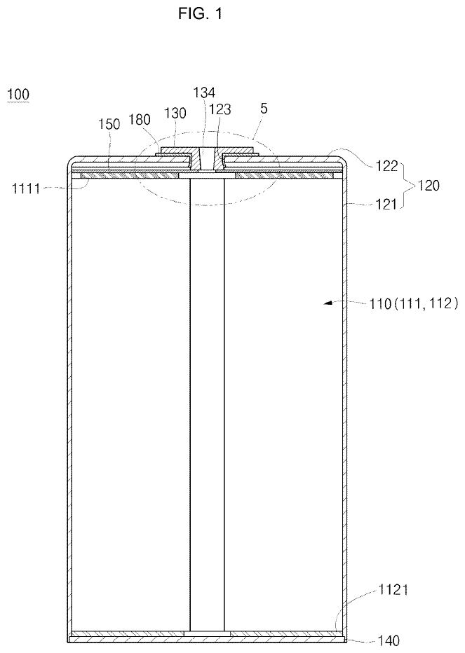

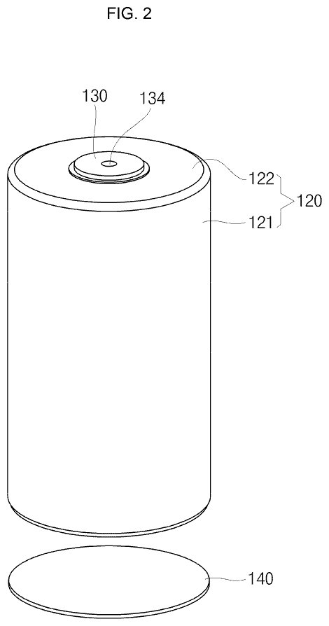

FIGS. 1 and 2 are cross-sectional and perspective views showing an exemplary secondary battery according to an embodiment of the present disclosure. Referring to FIGS. 1 and 2, the exemplary secondary battery 100 according to the present disclosure may include an electrode assembly 110, a can 120, a rivet terminal 130, and a first current collector plate 150. In some examples, the can 120 of the secondary battery 100 may include a bottom plate 140 coupled to and covering an opening at the bottom of the can 120. Herein, the bottom plate 140 is described as being included in the can 120, but the bottom plate 140 may be a separate component from the can 120 or an integral part of the can 120.

The electrode assembly 110 may include a separator, a first electrode plate 111 and a second electrode plate 112 positioned with the separator interposed therebetween, and the first and second electrode plates 111 and 112 and the separator may be wound in a jelly-roll form.

The first electrode plate 111 may include a first substrate and a first active material layer located on the first substrate. In the first substrate, a first uncoated portion where the first active material layer is not provided or a first tab 1111 may extend outward (e.g., upward). The first electrode plate 111 may be electrically connected to a rivet terminal 130 through the first current collector plate 150. The first current collector plate 150 and the first electrode plate 111 may be electrically and mechanically coupled to each other by welding, and the rivet terminal 130 may be electrically and mechanically connected to the first current collector plate 150 by welding. In some examples, the first tab 1111 may be electrically connected to the first current collector plate 150 and the rivet terminal 130.

The second electrode plate 112 may include a second substrate and a

second active material layer located on the second substrate. In the second substrate, a second uncoated portion where the second active material layer is not provided or a second tab 1121 may extend outward (e.g., downward). The second tab 1121 of the second electrode plate 112 may be electrically connected to the can 120. In some examples, the second tab 1121 may be electrically connected to the bottom plate 140.

In some examples, the first tab 1111 and the second tab 1121 may extend in opposite directions. In other examples, the first tab 1111 and the second tab 1121 may extend in the same direction, which will be described below.

The first electrode plate 111 may act as a positive electrode. In such an embodiment, the first substrate may be made of, for example, an aluminum foil, and the first active material layer may include, for example, a transition metal oxide. The second electrode plate 112 may act as a negative electrode. In such an embodiment, the second substrate may be made of, for example, a copper foil or a nickel foil, and the second active material layer may include graphite, for example.

The separator prevents a short circuit between the first electrode plate 111 and the second electrode plate 112 while allowing movement of lithium ions therebetween. The separator may be made of, for example, a polyethylene film, a polypropylene film, a polyethylene-polypropylene film, or the like. In some examples, the separator may be positioned on opposite sides of the first electrode plate 111 or on opposite sides of the second electrode plate 112.

In some examples, as the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiOs, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

The can 120 may accommodate the electrode assembly 110 and an electrolyte, and the can, including the bottom plate 140, may define the external appearance of the secondary battery 100. The can 120 may include a roughly cylindrical side wall portion 121 and an upper surface 122 connected to the upper side of the side wall portion 121. The can 120 may include, for example, a metal such as steel, nickel-plated steel, a steel alloy, aluminum, an aluminum alloy, or a cold sheet for deep drawing (SPCE), or a laminated film or plastic that constitutes a pouch.

The can 120 may have an opening provided in the other side, that is, the lower side. The bottom plate 140 may be fixed to the lower side of the can 120 to seal the can 120 so as to cover the lower opening of the can 120, and the bottom plate 140 may be electrically connected to the can 120. The bottom plate 140 may have an approximate disk shape and may be coupled to the bottom end of the can 120 by welding. The bottom plate 140 may be configured as part of the can 120 or may be separately configured, and may be coupled to the lower side of the can 120 to seal the can 120. The periphery of the bottom plate 140 may be coupled to the side wall portion 121 of the can 120 to seal the can 120. The bottom plate 140 may be made of iron, nickel-plated iron, stainless steel, aluminum, or an aluminum alloy. However, the bottom plate 140 is not limited to these examples and may be modified in various ways.

The present disclosure is not limited to the above embodiment, and the case may be configured in various shapes, such as a circular shape and a pouch shape. Further, the case may be made of a metal, such as aluminum, aluminum alloy, or nickel-plated steel, a laminated film, or plastic (e.g., in a pouch-type embodiment).

Referring to FIGS. 1, 2, and 5, a through-hole 123 may be formed in the central area of the upper surface 122 of the can 120, and a rivet terminal 130 may be installed in the through-hole 123. The rivet terminal 130 may be installed by riveting. The rivet terminal 130 may include a main body 131 that penetrates the through-hole 123 and a head 132 that is provided at one end of the main body 131. The head 132 may be formed larger than the through-hole 123 and is supported on the outer surface of the can 120. In addition, the rivet terminal 130 may include a bucktail 133 at the other end of the main body 131 that is larger than the through-hole 123 and may be supported on the inner surface of the can 120. The rivet terminal 130 may include, at the other end of the main body 131, the bucktail 133 that is deformed more than the through-hole 123 such that the bucktail 133 is supported on the inner surface of the can 120. The bucktail 133 may be brought into contact and welded to the first current collector plate 150, thereby forming an electrical and mechanical coupling between the rivet terminal 130 and the first current collector plate 150. In some examples, when the first current collector plate 150 of the electrode assembly 110 is a positive electrode, the rivet terminal 130 may function as a positive electrode terminal.

A gasket 180 may be interposed between the rivet terminal 130 and the can 120 for sealing and electrical insulation between the rivet terminal 130 and the can 120. The gasket 180 may be made of a resin material such as polyethylene (PE), polypropylene (PP), or polyethylene terephthalate (PET).

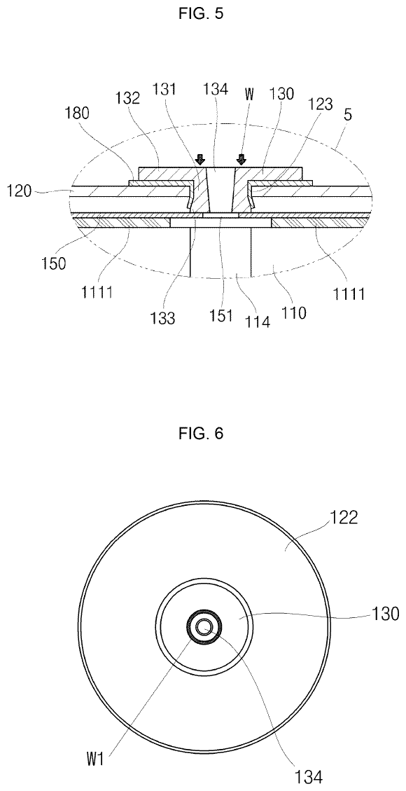

The first current collector plate 150 may include a current collector plate injection hole 151. The first current collector plate 150 may be a generally round disk shape, and a plurality of first tabs 1111 extending/protruding from the electrode assembly 110 may be electrically connected to the lower surface of the first current collector plate 150. The current collector plate injection hole 151 may be electrically/mechanically connected to the rivet terminal 130. An electrolyte may be injected through the current collector plate injection hole 151. Thus, the electrolyte may be provided directly to a core 114 (see FIG. 5) of the electrode assembly 110, and the electrolyte may then be absorbed into the electrode assembly 110. The first current collector plate 150 may include, for example, aluminum, an aluminum alloy, copper, a copper alloy, nickel, or a nickel alloy.

In some examples, the first current collector plate 150 may be connected (e.g., laser welded) to the first tab 1111. By compacting the first tab 1111 in one direction (for example, a direction toward the core or a direction away from the core), the first tab 1111 may be connected to the first current collector plate 150 such that the first tab 1111 lies in one direction. In some examples, the second tab 1121 may be connected (e.g., laser welded) to the bottom place 140. In some examples, by compacting the second tab 1121 in one direction (for example, a direction toward the core or a direction away from the core), the second tab 1121 may be connected to the bottom place 140 such that the second tab 1121 lies in one direction.

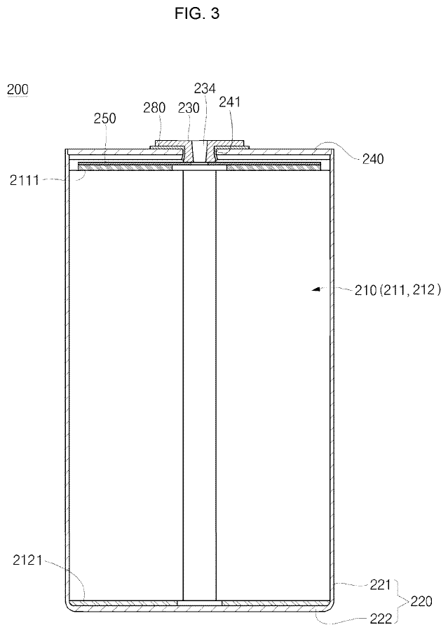

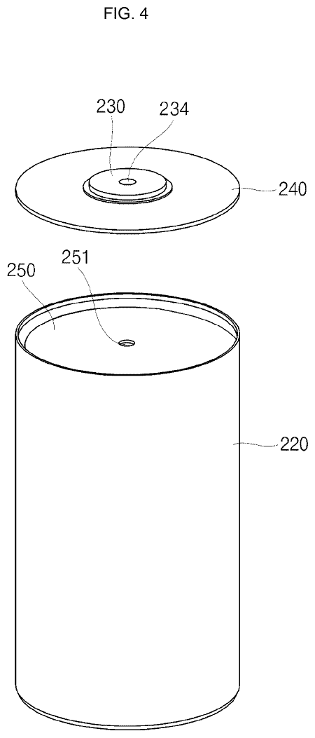

FIGS. 3 and 4 are cross-sectional and perspective views showing an exemplary secondary battery according to another embodiment of the present disclosure. Referring to FIGS. 3 and 4, the exemplary secondary battery 200 according to the present disclosure may include an electrode assembly 210, a can 220, a rivet terminal 230, and a first current collector plate 250. The can 220 of the secondary battery 200 may include a cap plate 240 coupled to and covering an opening at the upper side of the can 220. Although the cap plate 240 is described as being included in the can 220 herein, the cap plate 240 may be a separate component from the can 220. Hereinafter, the same features as those of the above-described secondary battery 100 will not be described or briefly described, and different features will be described.

In second electrode plate 212, a second uncoated portion or a second tab 2121, where a second active material layer is not provided in a second substrate, may extend outwardly (for example, to the lower side). The second tab 2121 of the second electrode plate 212 may be electrically connected to the can 220. In some examples, the second tab 2121 may be electrically connected to a bottom portion 222 of the can 220. The bottom portion 222 of the can 220 may be connected (e.g., laser welded) to the second tab 2121.

The cap plate 240 may be configured as part of the can 220 or may be separately provided, and the cap plate 240 may be coupled to the upper side of the can 220 to seal the can 220.

The can 220 may have an opening at one side, that is, the upper side, and the cap plate 240 may be fixed to the open upper side of the can 220 to cover the opening of the can 220 and may be electrically connected to the can 220. The cap plate 240 may be an approximate disk shape and may be coupled to the top end of the can 120 by welding. In some examples, the periphery of the top plate 240 may be coupled to a side wall portion 221 of the can 220 to seal the can 220. The cap plate 240 may be made of iron, nickel-plated iron, stainless steel, aluminum, or an aluminum alloy. However, the cap plate 240 is not limited to these examples and may be modified in various ways.

Referring to FIGS. 3 and 4, a through-hole 243 may be formed in the central area of the cap plate 240, and a rivet terminal 230 may be installed in the through-hole 243. The rivet terminal 130 may be installed by riveting. The rivet terminal 230 may penetrate the through-hole 243. The rivet terminal 230 may be brought into contact with and welded to the first current collector plate 250 to thereby form an electrical and mechanical coupling between the rivet terminal 230 and the first current collector plate 250. In some examples, when the first tab 2111 of the electrode assembly 210 is a positive electrode, the rivet terminal 230 may function as a positive electrode terminal.

A gasket 280 may be interposed between the rivet terminal 230 and the cap plate 240 to provide sealing and electrical insulation between the rivet terminal 230 and the cap plate 240. The gasket 280 may be made of a resin material such as polyethylene (PE), polypropylene (PP), or polyethylene terephthalate (PET).

FIG. 5 is an enlarged cross-sectional view showing area 5 of FIG. 1. FIG. 5 showns an example in which the rivet terminal 130 is coupled to the upper surface of the can 120, but the same configuration may also be applied to the can 220.

The rivet terminal 130 may include the rivet injection hole 134 for injection of electrolyte. The rivet injection hole 134 may extend in a vertical direction at the center of the rivet terminal 130. The rivet injection hole 134 may be formed such that an electrolyte can be injected into the can 120 after the bottom plate 140 is coupled to the can 120. Referring to FIGS. 2 and 5, the first current collector plate 150 may include the current collector plate injection hole 151 formed at a position corresponding to the rivet injection hole 134 of the rivet terminal 130. Accordingly, the rivet injection hole 134 of the rivet terminal 130 and the current collector plate injection hole 151 of the first current collector plate 150 may be in fluid communication with each other, and the electrolyte may be injected through the rivet injection hole 134 and the current collector plate injection hole 151 into the can 120.

Although not shown in the drawing, in some examples after injecting the electrolyte through the rivet injection hole 134, the rivet injection hole 134 may be sealed by welding a sealing portion positioned in the rivet injection hole 134 to the rivet terminal 130. In other examples, the sealing portion may be coupled, but not welded, to the rivet terminal 130. The sealing portion may block the current collector plate injection hole 151 and the rivet injection hole 134. The sealing portion may include, for example, aluminum, an aluminum alloy, copper, a copper alloy, nickel, or a nickel alloy. Various shapes and materials that can block the hole, such as a seal pin or disk shape, may be used as the sealing portion.

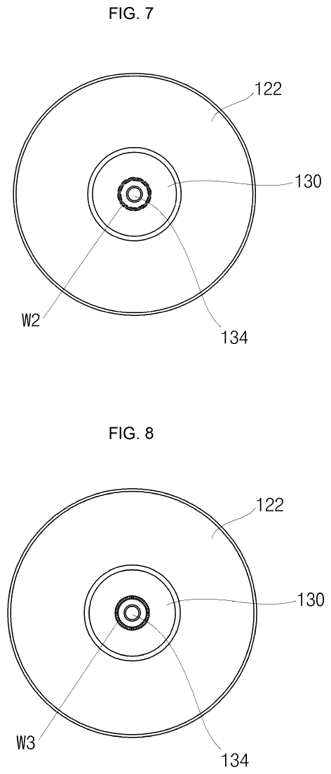

FIG. 6 is a plan view showing a welding line of a rivet terminal according to an embodiment of the present disclosure. FIG. 7 is a plan view showing a welding line of a rivet terminal according to another embodiment of the present disclosure. FIG. 8 is a plan view showing a welding line of a rivet terminal according to still another embodiment of the present disclosure. FIGS. 6 to 8 show welding forms of a rivet terminal according to various embodiments of the present disclosure.

Referring to FIG. 6, a welding line W1 applied to the rivet terminal 130 may be circular. The welding line W1 may be shaped to correspond to the rivet injection hole 134 of the rivet terminal 130. For example, the welding line W1 may be extend along the periphery of the rivet injection hole 134 of the rivet terminal 130.

Referring to FIG. 7, a welding line W2 applied to the rivet terminal 130 may be in the form of a dotted line. In particular, the welding line W2 may be shaped of a dotted circle extending along the periphery of the rivet injection hole 134 of the rivet terminal 130.

Referring to FIG. 8, a welding line W3 applied to the rivet terminal 130 may have a wobble shape. The welding line W3 may be shaped of a wobble extending along the periphery of the rivet injection hole 134 of the rivet terminal 130.

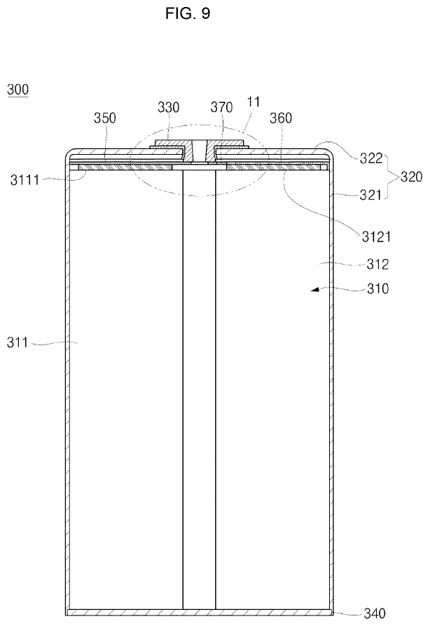

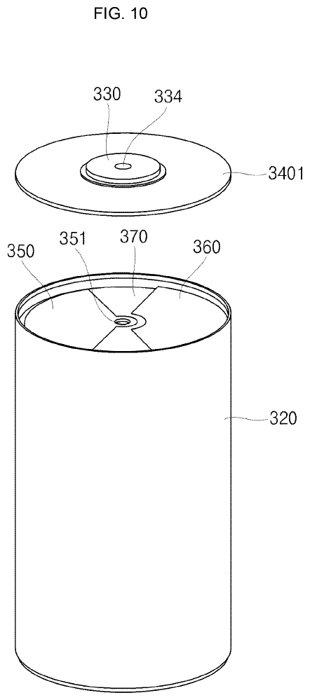

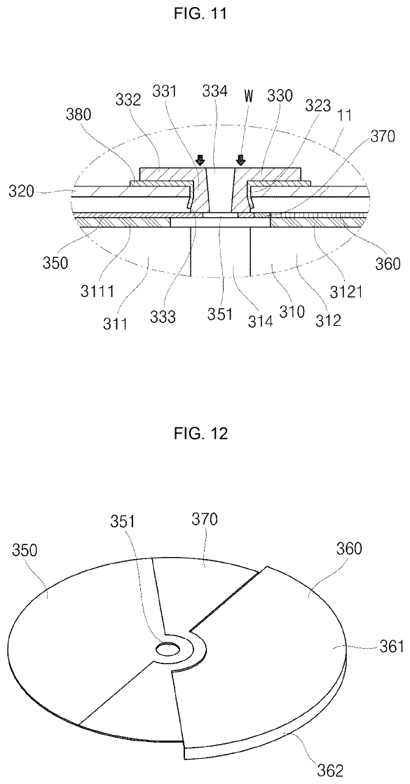

FIG. 9 is a cross-sectional view showing a secondary battery having an exemplary bottom plate structure according to another embodiment of the present disclosure. FIG. 10 is a perspective view showing a secondary battery having an exemplary cap plate structure according to another embodiment of the present disclosure. FIG. 11 is an enlarged cross-sectional view showing area 11 of FIG. 9. FIG. 12 shows the shapes of a first current collector plate and a second current collector plate in a secondary battery having positive and negative electrode tabs protruding in one direction, according to an embodiment of the present disclosure. Referring to FIGS. 9 to 12, an exemplary secondary battery 300 according to the present disclosure may include an electrode assembly 310, a can 320, a rivet terminal 330, a first current collector plate 350, and a second current collector plate 360.

Referring to FIG. 9, in some examples the can 320 of the secondary battery 300 may include an opening at its bottom. And the can 320 may include a bottom plate 340 that covers the opening. However, the present disclosure is not limited to such a configuration. And referring to FIG. 10, the secondary battery 300 may have an opening in the upper side of the can 320, and a cap plate 3401 may be coupled to the upper side.

Referring to FIGS. 9 to 12, a first tab 3111 and a second tab 3121 may protrude in one direction. In some examples, the first tab 3111 of a first electrode plate 311 and the second tab 3121 of a second electrode plate 312 may in upward direction of the can 320 as shown in FIGS. 9 to 12. In such a configuration, the first current collector plate 350 and the second current collector plate 360 may be disposed on the upper side of the can 320.

Referring to FIG. 12, the first current collector plate 350 may be roughly fan-shaped, and the second current collector plate 360 may include a flat portion 361 that is roughly fan-shaped. The flat portion 361 of the second current collector plate 360 may be coupled to the second electrode plate 312. In addition, the second current collector plate 360 may include a protrusion 362 extending from the edge of the flat portion 361. The protrusion 362 may protrude toward the electrode assembly 310 and may be welded along a welding line to the lateral side of the can 320, that is, the portion where the protrusion 362 is located on the side wall portion 321.

In some examples, an insulating gasket 370 for providing electrical insulation may be interposed between the first current collector plate 350 and the second current collector plate 360. By preventing contact between the first current collector plate 350 and the second current collector plate 360, the insulating gasket 370 may electrically separate the first current collector plate 350 and the second current collector plate 360. The insulating gasket 370 may be made, for example of a resin material such as polyethylene (PE), polypropylene (PP), or polyethylene terephthalate (PET). An adhesive material may be attached to a portion where the first current collector plate 350 and the insulating gasket 370 contact so that the first current collector plate 350 and the insulating gasket 370 are fixed to each other, and the adhesive material may be attached to a portion where the second current collector plate 360 and the insulating gasket 370 contact so that the second current collector plate 360 and the insulating gasket 370 are fixed to each other. Referring to FIG. 12, the first current collector plate 350 and the second current collector plate 360 may be roughly fan-shaped. The first and second current collector plates 350 and 360 may be spaced apart to be electrically insulated from each other, and the insulating gasket 370 may be interposed between the first and second current collector plates 350 and 360.

The first current collector plate 350 may include a current collector plate injection hole 351 formed at a position corresponding to the rivet injection hole 334 of the rivet terminal 330. An adhesion member having an adhesive property may be attached to a portion where the first current collector plate 350 and the insulating gasket 370 contact and to a portion where the second current collector plate 360 and the insulating gasket 370 contact. The first current collector plate 350, the second current collector plate 360, and the insulating gasket 370 may be coupled to each other in an roughly disk shape.

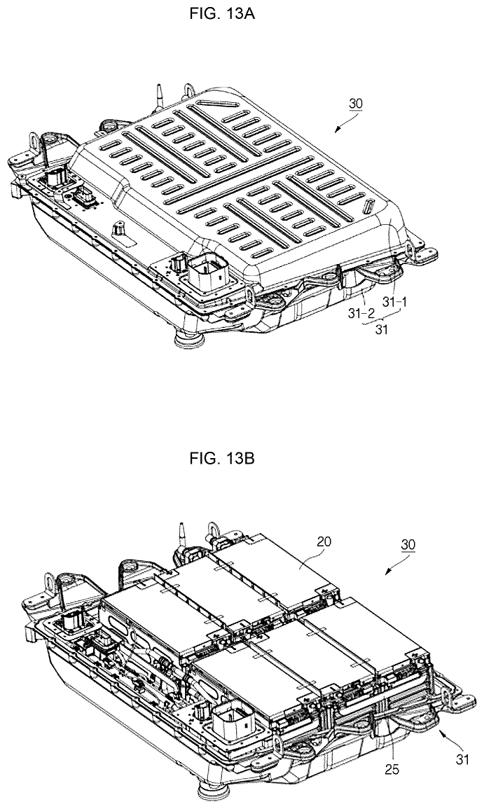

The secondary battery 100 according to the above-described embodiment can be used to manufacture a secondary battery pack 30. FIGS. 13A and 13B illustrate perspective views of an example of a battery pack 30.

Referring to FIGS. 13A and 13B, the battery pack 30 may include a plurality of battery modules 20 and a housing 31 for accommodating the plurality of battery modules 20. For example, the housing 31 may include first and second housings 31-1 and 31-2 coupled in opposite directions through the plurality of battery modules 20. The plurality of battery modules 20 may be electrically connected to each other by using a bus bar 25, and the plurality of battery modules 20 may be electrically connected to each other in a series/parallel or series-parallel mixed method, thereby obtaining desired (e.g., required) electrical output. In the drawings, for convenience of illustration, components including a bus bar, a cooling unit, external terminals for electrically connecting batteries, etc., are not shown.

The battery pack 30 may be mounted on (or in) a vehicle 50. The vehicle 50 may be, for example, an electric vehicle, a hybrid vehicle, or a plug-in hybrid vehicle. The vehicle may be a four-wheeled vehicle or a two-wheeled vehicle but is not limited thereto.

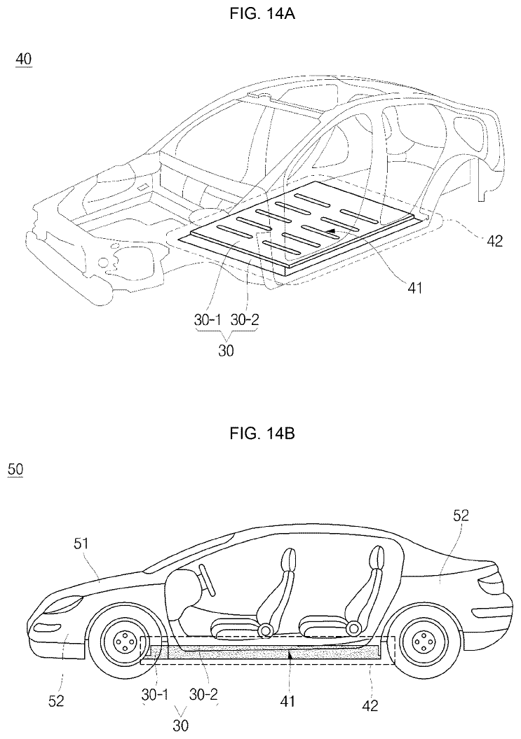

FIG. 14A illustrate perspective and side views of examples of a vehicle body. FIG. 14B is a drawing for explaining a vehicle 50 including the secondary battery pack 30 of FIG. 13. In FIG. 14A, a battery pack 30 may include a battery pack cover 30-1, which is a part of a vehicle underbody 41, and a pack frame 30-2 disposed under the vehicle underbody 41. In some examples, the battery pack cover 30-1 may correspond to the first housing 31-1, and the pack frame 30-2 may correspond to the second housing 31-2. The pack frame 30-2 and the battery pack cover 30-1 may be integrally formed with a vehicle floor 42. The vehicle underbody 41 separates the inside and outside of a vehicle, and the pack frame 31-2 may be disposed outside the vehicle.

Referring to FIG. 14B, a vehicle 50 may be formed by combining additional parts, such as a hood 51 in front of the vehicle and fenders 52 respectively located in the front and rear of the vehicle to a vehicle body 40. The vehicle 50 may include the battery pack 30 that include the battery pack cover 30-1 and the pack frame 30-2, and the battery pack 30 may be coupled to the vehicle body 40. That is, the vehicle operates by receiving power from a secondary battery pack 30 according to one embodiment of the present disclosure.

According to the present disclosure, a process of injecting an electrolyte is enabled by providing an injection port toward a positive electrode. Further, sealing can be ensured by eliminating a blind rivet structure of a negative electrode, and the welding strength of a positive electrode terminal can be secured and the ability to detect defect can be increased. In addition, by placing the injection port on a positive electrode side, the risk of rust occurring during welding to seal the injection port can be eliminated.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. A secondary battery comprising:
a cylindrical can having a through-hole formed therein;
an electrode assembly accommodated in the can, the electrode assembly including a first tab and a second tab;
a current collector plate accommodated in the can, the current collector plate connected to the first tab, and the current collector plate including a current collector plate injection hole; and
a rivet terminal coupled to the through-hole and electrically connected to the first tab,
wherein the rivet terminal includes a rivet injection hole through which an electrolyte may be injected.

2. The secondary battery as claimed in claim 1, wherein the current collector plate injection hole and the rivet injection hole are coupled to each other at positions corresponding to each other.

3. The secondary battery as claimed in claim 1, wherein the can comprises an upper surface, a side wall portion extending from the periphery of the upper surface, and a bottom portion having an opening, and the through-hole is formed in the upper surface.

4. The secondary battery as claimed in claim 3, wherein the can further comprises a bottom plate that closes the opening in the bottom portion of the can to isolate the electrode assembly and the current collector plate from outside of the can, and the bottom plate is coupled to the bottom portion of the can.

5. The secondary battery as claimed in claim 3, wherein the bottom plate is electrically connected to the second tab.

6. The secondary battery as claimed in claim 1, wherein the can comprises a bottom portion, a side wall portion extending from the periphery of the bottom portion, and an upper surface having an opening formed therein.

7. The secondary battery as claimed in claim 6, wherein the can further comprises a cap plate that closes the opening in the upper surface of the can to isolate the electrode assembly and the current collector plate from outside of the can, and the cap plate is coupled to the upper surface of the can.

8. The secondary battery as claimed in claim 6, wherein the can is electrically connected to the second tab.

9. The secondary battery as claimed in claim 1, wherein the first tab and the second tab protrude from the electrode assembly in the same direction.

10. The secondary battery as claimed in claim 9, wherein the current collector plate is a first current collector plate, and
wherein the secondary battery further comprises a second current collector plate positioned beside of the first current collector plate and electrically connected to the second tab.

11. The secondary battery as claimed in claim 10, further comprising an insulating gasket positioned between the first current collector plate and the second current collector plate.

12. The secondary battery as claimed in claim 1, wherein the first tab and the second tab protrude from the electrode assembly in opposite directions.

13. The secondary battery as claimed in claim 1, wherein a welding line is formed on the top of the rivet terminal where the rivet terminal is connected to the current collector plate.

14. The secondary battery as claimed in claim 1, wherein an upper side of the rivet injection hole of the rivet terminal and an upper side of the current collector plate injection hole are coupled to each other by laser welding.

15. The secondary battery as claimed in claim 13, wherein the welding line is formed along the periphery of the rivet injection hole.

16. The secondary battery as claimed in claim 13, wherein the welding line corresponds to the shape of the rivet injection hole.

17. The secondary battery as claimed in claim 13, wherein the welding line is in any of circular, dotted, and wobble shaped.

18. The secondary battery as claimed in claim 1, wherein the rivet terminal further comprises a sealing portion positioned in the rivet injection hole.

19. The secondary battery as claimed in claim 1, further comprising a sealing portion that seals the rivet injection hole and the current collector plate injection hole.

20. The secondary battery as claimed in claim 19, wherein the sealing portion includes aluminum, an aluminum alloy, copper, a copper alloy, nickel, or a nickel alloy.
